(19) United States
(12) Patent Application Publication
(10) Pub. No.: US 2004/0252835 A1
(43) Pub. Date: Dec. 16, 2004

(54) Method for spoiling copies of a theatrical motion picture made using a video camera and recorder

(76) Inventor: Christopher R. Odgers, Claremont, CA (US)

Correspondence Address: GOTTLIEB RACKMAN & REISMAN PC, 270 MADISON AVENUE, 8TH FLOOR, NEW YORK, NY, 100160601

(21) Appl. No.: 10/828,036

(22) Filed: Apr. 20, 2004

Related U.S. Application Data
(60) Provisional application No. 60/464,913, filed on Apr. 23, 2003.

(51) Int. Cl. H04N 5/91

(52) U.S. Cl. 380/201; 386/94

(57) ABSTRACT

In movie house or similar installation for projecting still or moving normal visible images on a screen, a laser device is used to project an infrared spoiling image simultaneously with the normal visible image. When a camcorder is used to record the screen to make illegal copies of the normal visible images, the light sensitive elements of the camcorder convert the invisible spoiling image into a corresponding normal visible image thereby spoiling it.

### RELATED APPLICATIONS

This application claims priority to provisional application Ser. No. 60/464,913 filed Apr. 23, 2003 and incorporated herein by reference.

### BACKGROUND OF THE INVENTION

1. Field of the Invention

The present invention relates to a method and apparatus in the field of motion picture projection and, and more particularly, to a method and apparatus for spoiling copies of a motion picture made from projected images using a video camera.

2. Description of Prior Art

A big problem facing the motion picture industry is that of piracy. Unauthorized copies are often made during the postproduction and the distribution of a motion picture. Because prints of motion pictures are sometimes previewed before the official release and received by exhibitors in advance, illicit copies of films are often available on disc or over the Internet prior to their release in theaters. Frequently, unauthorized copies are made by pirates in a screening room or movie house during the normal showing of the motion picture, by using a hand-held standard video camera, or camcorder. While the quality of the motion pictures made this way is very poor, apparently there are still sufficient customers who are willing to tolerate them to make the effort of the pirates worthwhile. Once an illicit copy of a motion picture film is obtained, it is illegally distributed through various means. The recorded film is converted into any one of various digital formats such as DVD, VCD or Divx, and distributed on DVD, CD ROMs or over the Internet. This illegal activity causes substantial financial damage to motion picture distributors and exhibitors. It was proposed that one way of combating film piracy in this manner is to spoil the copy as it is recorded. For example, U.S. Pat. No. 6,018,374 by Wrobleski, describes projecting an infrared spoiling image onto the screen during the exhibition of the normal images of a motion picture. This image is invisible to the viewers. However, camcorders use light-sensing elements such as an array of CCDs that translate infrared light to the visible spectrum. In this case, the infrared spoiling image is superimposed as a visible spoiling image on top of the normal images as they are being copied by the camcorder. However, consumer camcorders are provided with an infrared blocking filter, which greatly reduces the amount of infrared energy reaching the light sensing elements. This filter diminishes significantly the intensity of the infrared spoiling image and, as a result, the corresponding visible spoiling image has also a much lower intensity then the normal images being copied. Hence, the spoiling visible image becomes almost invisible, and therefore this technique is not very effective.

### SUMMARY OF THE INVENTION

The present invention provides a method and apparatus for creating intense infrared spoiling images on a motion picture screen simultaneously with the normal images of the motion picture. Preferably, the spoiling images are ‘painted’ over at least a substantial portion of the screen using a fast moving spot generated by an infrared (IR) laser beam. A camcorder copying the normal images must be used with a slow shutter speed to prevent a flicker effect caused by the fact that the camcorder and film projector run asynchronously. As a result, the moving IR laser spot appears as a bright visible spoiling image superimposed on the copied images.

The laser beam is generated by an infrared laser generator incorporated in an optical deflection system, similar to the ones used to produce laser light shows for entertainment purposes. A controller is provided to operate the deflection system and produce bright complex, optionally moving IR images. Because the CCD imaging sensors used in the consumer camcorders typically used to produce pirated copies of theatrical films are very sensitive near infrared range, it is desirable that the laser used to create the infrared patterns emit in this range. For example, solid state lasers that emit in the near infrared are readily available.

In one embodiment of the invention, the optical deflection system includes rotating or oscillating mirrors actuated by precision galvanometers. The mirrors are moved by the application of a voltage to the galvonometer. Two of these galvonometer/mirror combinations can be configured in such a way as to deflect a laser beam along X and Y axes.

The electronic drivers for the galvanometers receive commands from a controller. The controller can be are controlled by a computer so that complex graphic patterns may be drawn by the laser beam.

During the presentation of a motion picture, the laser system projects the non-visible infrared laser image onto the viewing screen. Many different still and/or moving patterns may be generated by the laser. The light from the laser is of a wavelength that will be invisible or unnoticeable to human observation during the motion picture presentation but will be recorded by a video recording device, such as a camcorder. For example, light in a range of 750-900 nanometers generated by a laser with an appropriate intensity or power can have the desired effect. Thus, when the movie image is recorded by the recording device, the video copy of the motion picture will contain the image generated by the laser. Since the laser generated image will be distracting to the viewer of the video copy of the motion picture, the commercial value of an unlawful copy may be reduced. Alternatively, the optical deflection system includes a mount for the laser generator that is capable of rotating or oscillating along two orthogonal axes, and motors coupled to the mount and responsive to commands.

### BRIEF DESCRIPTION OF THE DRAWINGS

FIG. 1 is a diagram side-sectional view of a movie house showing the apparatus delivering the spoiling image;

FIG. 2A shows an image being showed on the screen of FIG. 1;

FIG. 2B shows an infrared spoiling image painted on the screen by the laser spot;

FIG. 2C shows the resultant visible spoiling image superimposed on the image of FIG. 2A;

FIG. 3 shows a first embodiment of a device for generating a moving IR laser spot; and

FIG. 4 shows a second embodiment of a device for generating a moving IR laser spot.

### DETAILED DESCRIPTION OF THE PREFERRED EMBODIMENTS

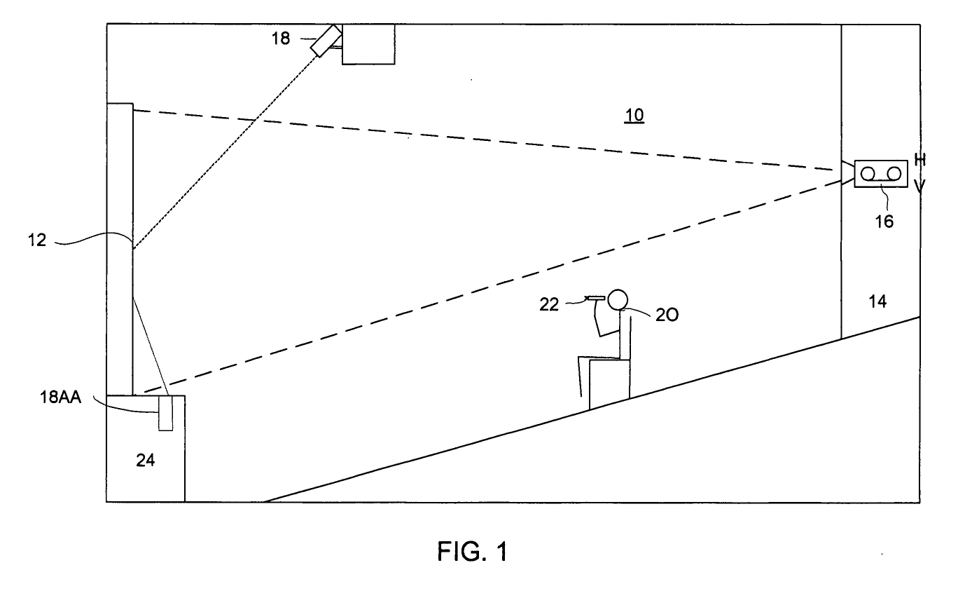

FIG. 1 shows a typical movie house 10 with a vertical screen 12, a projection room 14 with a projector 16, and a laser device 18. The projector projects a sequences of images forming a motion picture on screen 12. A viewer 20 is using a camcorder 22 to record or copy the images on the screen 12.

In order to spoil the images being recorded by the camcorder 22, the laser device 18 generates a moving IR laser beam onto screen 12. The laser device 18 is mounted on the ceiling as shown so that it is completely or almost completely invisible to the patrons. Alternatively, the laser device can be disposed inside a platform 24, as indicated at 18AA, or at other locations within the movie house. The invention is typically applicable to restricted screenings in commercial theatres, private screening rooms in studios, or other locations.

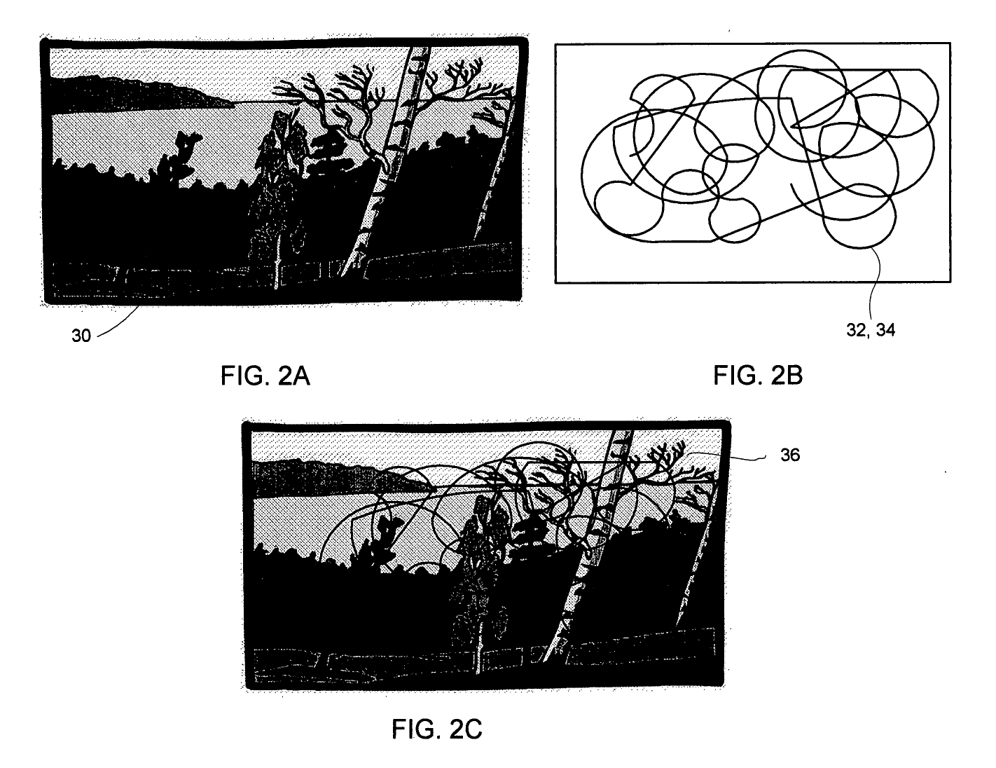

FIG. 2A shows a typical visible image 30 from projector 16 on screen 12. This image 30 is preferably a normal image that is part of a motion picture, although it could be a still image as well. FIG. 2B shows an invisible IR spoiling image 32 generated by laser device 18. As discussed above, although the laser device generates only a laser beam terminating in a laser spot on the screen, this spot moves very rapidly. The shutter (not shown) of the camcorder 22 is opened for a sufficiently long enough time so that the image of the spot falls on several CCDs (not shown) or other light sensing elements which translate the resulting IR spoiling image 32 into a corresponding visible spoiling image 34. In this manner the camcorder superimposes the corresponding visible spoiling image 34 onto the normal image 30 from the projector 26. The resulting composite image includes both images 30 and 34 simultaneously, as shown in FIG. 2C. Preferably, the spoiling images 32, 34 extend over a substantial portion of the screen 12 to insure that as much of the normal image 30 is spoiled as possible. The visible spoiling image 34 appears in the camcorder 22 as a bright line, typically white, that renders the composite image 36 hard or annoying to watch. The visible spoiling image 34 can remain the same for a substantial time period, or it can be changing relatively rapidly, (for example, every couple of frames, or every couple of seconds) to render the images 36 even more confusing.

The laser device 18 can be operated independently of the projector 16, or the two devices can be operated simultaneously.

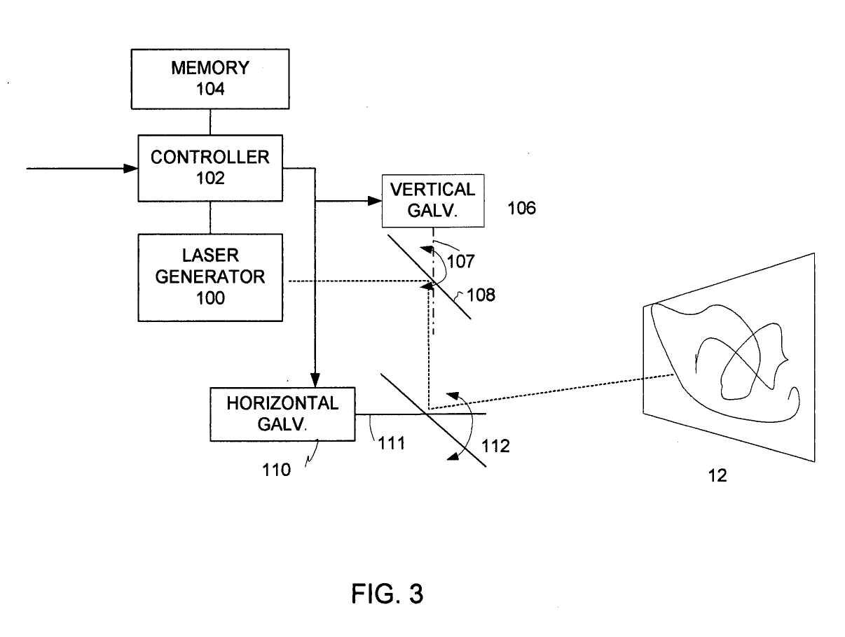

FIG. 3 shows a first embodiment of the laser device 18. In this embodiment, device 18 includes a laser generator 100 and a laser beam deflection system including a controller 102 with a memory 104, a first galvanometer 106, a first mirror 108, a second galvanometer 110 and a second mirror 112. The memory 104 is used to store one or more spoiling images 32, 34, such as the one shown on FIGS. 2B and 2C, or FIG. 3. Controller 102 accesses the memory 104 and retrieves data defining these images as needed and generates corresponding control signals. The elements of the laser deflection system are available, for example, from Cambridge Technology, Inc., Cambridge, Mass. 02138. The galvanometers 106, 110 each have an inductive coil that generates a magnetic field and rotate a respective shaft. The angle of rotation of the shaft is related to the control signal received by the respective galvanometer. In FIG. 3, vertical galvanometer 106 has a shaft 107 oriented along a vertical axis and supporting mirror 108. Horizontal galvanometer 110 has a shaft 111 disposed along a horizontal axis and supporting mirror 112. The mirrors on the galvanometers have a coating that reflects as much infrared energy as possible.

The device 18 operates as follows. The controller 102 (which may be initiated by an external command) sends control signals to the galvanometers 106, 110 corresponding to a particular image. Meanwhile, the laser generator (which may be, for example, an LED or other kind of semiconductor laser) generates a laser beam in the infrared region, e.g., having a wavelength of about 750-900 nanometers. This laser beam first hits mirror 108.

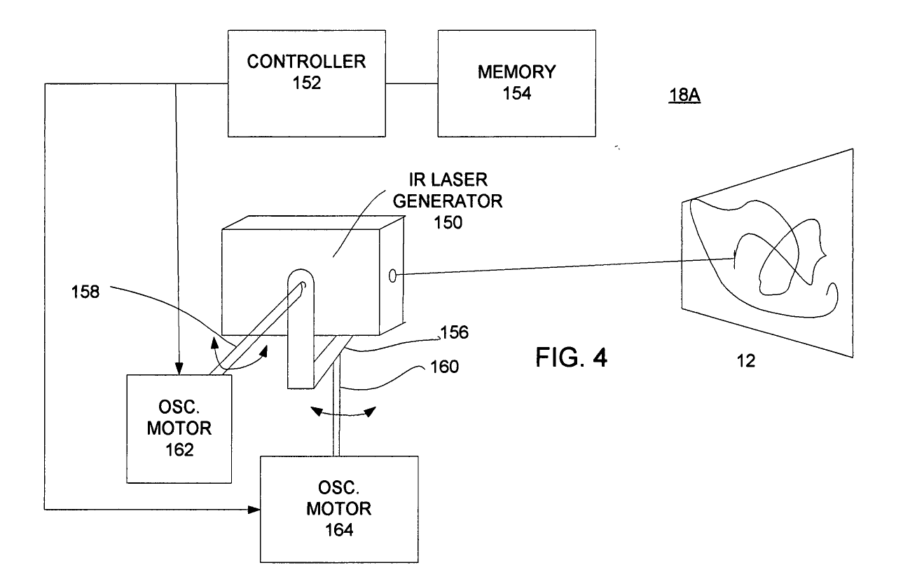

The mirror 108 is reciprocated rapidly by galvanometer 106 directing the beam in a vertical plane toward mirror 112. Mirror 112 is reciprocated rapidly by its galvanometer 110 and directs the beam toward the screen 12 as shown. The movement of the mirrors 110, 112 is controlled in a manner so as to paint the selected invisible spoiling image on the screen 12 superimposed on the normal image 30 from the projector 16. FIG. 4 shows an alternate embodiment for the laser device. In this embodiment, device 18A includes an IR laser generator 150 and a laser deflecting system consisting of a controller 152 with a memory 154. The controller 152 receives imaging information from memory 154. The laser generator 150 is rotatably mounted on a U-shaped bracket 156 by a horizontal shaft 158. The bracket 156 is mounted on a vertical shaft 160. A first oscillating motor 162 is coupled to shaft 158 and, in response to commands from controller 152, it rotates or oscillates the shaft 158 and laser generator 150 to sweep its beam in a vertical plane. Similarly, a second oscillator motor 164 rotates or oscillates shaft 160 in response to commands from controller 152. In this manner, the controller 152 causes the laser beam generator to paint an IR image on screen 12. In one embodiment, the IR image from either device 18 or 18A can cover the whole screen 12. In another embodiment, several devices can be provided, each device generating respective IR images that are painted on respective portions of the screen 12. The IR images from different laser devices can overlap. In FIG. 1, device 18 is shown mounted on, or near the ceiling of the 10, while device 18AA can be disposed at the bottom of the screen 12 as shown.

Although the invention has been described with reference to particular forms, it is to be understood that these are merely illustrative of an application of the principles of the invention. Numerous modifications, may be made and other arrangements may be devised without departing from the spirit and scope of the invention.

I claim:

1. An installation for exhibiting one or more images to viewers comprising:
a screen;
a projector directing a visible image at said screen; and a laser device generating an infrared image on said screen superimposed on said visible image by moving an infrared spot rapidly in a predetermined pattern selected to spoil said visible image if said visible image and said infrared image are copied.

2. The installation of FIG. 1 wherein said installation includes two opposed ends with said screen being disposed at one end, said projector being disposed at the other end, and said laser device being disposed between said ends.

3. The installation of FIG. 1 further comprising a ceiling, with said laser device being affixed to said ceiling.

4. The installation of claim 1 wherein said laser device is disposed above said screen.

5. The installation of claim 1 wherein said laser device is disposed below said screen.

6. An installation for exhibiting images comprising:
a screen; a projector directing a visible image at the screen; and
a laser device including a laser generator generating a laser beam and a laser deflecting system directing said laser beam at said screen to generate an infrared image, said infrared image being superimposed on a portion of said visible image to spoil said image when said screen is recorded by a camcorder having light sensing elements sensitive to infrared light.

7. The installation of claim 6 wherein said laser deflecting system includes two mirrors oscillating with respect to two axes, said laser beam being reflected sequentially by said mirrors.

8. The installation of claim 7 further comprising two galvanometers responsive to commands to oscillate said mirrors.

9. The installation of claim 7 wherein said axes are orthogonal.

10. The installation of claim 6 wherein said laser deflecting system includes a mount supporting said laser generator, said mount being pivotable simultaneously about two axes.

11. The installation of claim 10 wherein said laser deflecting system includes a first motor oscillating said mount about a first axis and a second motor oscillating said mount about a second axis.

12. The installation of claim 10 wherein said axes are orthogonal.

13. The installation of claim 6 further comprising a controller generating commands for the deflection of the beam.

14. The installation of claim 13 further comprising a memory holding data descriptive of said infrared image, said controller receiving said data from said memory and generating said commands in accordance with said data.

15. A method of spoiling a visible image on a screen comprising:
generating an invisible laser beam; and directing said invisible laser beam at said screen in a predetermined pattern to form an invisible image simultaneously with a visible image;
said invisible image being selected to spoil said visible image if both are recorded by a camcorder.

16. The method of claim 15 further comprising directing said invisible laser beam sequentially to a first and second mirror and moving said mirrors in a preselected pattern to paint said invisible image on the screen.

17. The method of claim 16 further comprising oscillating said first and second mirrors with galvanometers.

18. The method of claim 17 further comprising generating commands to said galvanometers to generate said invisible image.

19. The method of claim 15 further comprising directing said laser beam using two oscillating motors.

20. The method of claim 15 further directing more than one invisible laser beam at the screen.
